(19) United States
(12) Patent Application Publication
(10) Pub. No.: US 2004/0149322 A1
(43) Pub. Date: Aug. 5, 2004

(54) Automatically-adjusting substrate rinsing system

(75) Inventors: Richard Peng, Hsinchu (TW); Kuo-Hsing Teng, Hsinchu (TW)

Correspondence Address: TUNG & ASSOCIATES, 838 W. Long Lake Road, Suite 120, Bloomfield Hills, MI, 48302, US

(73) Assignee: Taiwan Semiconductor Manufacturing Co., Ltd.

(21) Appl. No.: 10/355,770

(22) Filed: Jan. 31, 2003

(51) Int. Cl. B08B 3/00

(52) U.S. Cl. 134/56 R; 134/172

(57) ABSTRACT

A new and improved system for rinsing substrates. The substrate-rinsing system includes at least one rinsing unit having a nozzle that is angularly and linearly adjustable with respect to the substrate. A controller may be used to automatically control the angular and linear positions of the nozzle during the substrate-rinsing procedure in order to facilitate timely and effective rinsing or cleaning of the substrate.

### FIELD OF THE INVENTION

The present invention relates to photolithography processes used in the formation of integrated circuit (IC) patterns on photoresist in the fabrication of semiconductor integrated circuits. More particularly, the present invention relates to an automatically-adjusting substrate rinsing system which automatically adjusts the position and angle of rinsing nozzles on a developer coater for rinsing developer solution, for example, from the backside of semiconductor wafers.

### BACKGROUND OF THE INVENTION

The fabrication of various solid state devices requires the use of planar substrates, or semiconductor wafers, on which integrated circuits are fabricated. The final number, or yield, of functional integrated circuits on a wafer at the end of the IC fabrication process is of utmost importance to semiconductor manufacturers, and increasing the yield of circuits on the wafer is the main goal of semiconductor fabrication. After packaging, the circuits on the wafers are tested, wherein non-functional dies are marked using an inking process and the functional dies on the wafer are separated and sold. IC fabricators increase the yield of dies on a wafer by exploiting economies of scale. Over 1000 dies may be formed on a single wafer which measures from six to twelve inches in diameter.

Various processing steps are used to fabricate integrated circuits on a semiconductor wafer. These steps include deposition of a conducting layer on the silicon wafer substrate; formation of a photoresist or other mask such as titanium oxide or silicon oxide, in the form of the desired metal interconnection pattern, using standard lithographic or photolithographic techniques; subjecting the wafer substrate to a dry etching process to remove the conducting layer from the areas not covered by the mask, thereby etching the conducting layer in the form of the masked pattern on the substrate; removing or stripping the mask layer from the substrate typically using reactive plasma and chlorine gas, thereby exposing the top surface of the conductive interconnect layer; and cooling and drying the wafer substrate by applying water and nitrogen gas to the wafer substrate.

Photoresist materials are coated onto the surface of a wafer by dispensing a photoresist fluid typically on the center of the wafer as the wafer rotates at high speeds within a stationary bowl or coater cup. The coater cup catches excess fluids and particles ejected from the rotating wafer during application of the photoresist. The photoresist fluid dispensed onto the center of the wafer is spread outwardly toward the edges of the wafer by surface tension generated by the centrifugal force of the rotating wafer. This facilitates uniform application of the liquid photoresist on the entire surface of the wafer.

During the photolithography step of semiconductor production, light energy is applied through a reticle mask onto the photoresist material previously deposited on the wafer to define circuit patterns which will be etched in a subsequent processing step to define the circuits on the wafer. A reticle is a transparent plate patterned with a circuit image to be formed in the photoresist coating on the wafer. A reticle contains the circuit pattern image for only a few of the die on a wafer, such as four die, for example, and thus, must be stepped and repeated across the entire surface of the wafer. In contrast, a photomask, or mask, includes the circuit pattern image for all of the die on a wafer and requires only one exposure to transfer the circuit pattern image for all of the dies to the wafer.

The numerous processing steps outlined above are used to cumulatively apply multiple electrically conductive and insulative layers on the wafer and pattern the layers to form the circuits. The final yield of functional circuits on the wafer depends on proper application of each layer during the process steps. Proper application of those layers depends, in turn, on coating the material in a uniform spread over the surface of the wafer in an economical and efficient manner.

Spin coating of photoresist on wafers, as well as the other steps in the photolithographty process, is carried out in an automated coater/developer track system using wafer handling equipment which transport the wafers between the various photolithography operation stations, such as vapor prime resist spin coat, develop, baking and chilling stations. Robotic handling of the wafers minimizes particle generation and wafer damage. Automated wafer tracks enable various processing operations to be carried out simultaneously. Two types of automated track systems widely used in the industry are the TEL (Tokyo Electron Limited) track and the SVG (Silicon Valley Group) track.

A typical method of forming a circuit pattern on a wafer includes introducing the wafer into the automated track system and then spin-coating a photoresist layer onto the wafer. The photoresist is next cured by conducting a soft bake process. After it is cooled, the wafer is placed in an alignment and exposure apparatus, such as a stepper, which aligns the wafer with an array of die patterns etched on the typically chrome-coated quartz reticle. When properly aligned and focused, the stepper exposes a small area of the wafer, then shifts or “steps” to the next field and repeats the process until the entire wafer surface has been exposed to the die patterns on the reticle. The photoresist, which may be either positive or negative, is exposed to light through the reticle in the circuit image pattern. Negative photoresist is cross-linked, or hardened, by exposure to UV light in the image of the circuit pattern, and therefore the exposed regions are rendered insoluble and the unexposed regions are rendered soluble to developer solution. The light-exposed regions of positive photoresist, on the other hand, are rendered soluble to developer solution after exposure to the UV light, whereas the unexposed regions remain insoluble to the developer solution. After the aligning and exposing step, the wafer is exposed to post-exposure baking and then is developed and hard-baked, and finally, inspected.

During the photoresist development step, a liquid chemical developer is applied to the wafer to dissolve the soluble regions of the resist that were formed during mask or reticle exposure. Accordingly, in the case of negative photoresist, the soluble, unexposed regions of the photoresist are dissolved and the insoluble, cross-linked exposed regions remain in the form of the circuit pattern. In the case of positive photoresist, the soluble, exposed regions of the photoresist are dissolved and the insoluble, unexposed regions remain in the form of the circuit pattern.

The circuit pattern defined by the developed and hardened photoresist is next transferred to the underlying metal conductive layer using a metal etching process, in which metal over the entire surface of the wafer and not covered by the photoresist is etched away from the wafer with the metal under the photoresist that defines the circuit pattern protected from the etchant. As a result, a well-defined pattern of metallic microelectronic circuits which closely approximates the photoresist circuit pattern remains in the metal layer.

During the photoresist developing step, the liquid developer solution dispensed onto the wafer adheres to the wafer backside, particularly in the case of 300 mm wafers, because the wafer is typically polished on both the front and backside surfaces. Accordingly, the developer solution must be washed from the wafer backside prior to resuming processing of the wafer. A side view of a typical conventional developer rinsing system 10 for rinsing excess developing liquid 36 from the backside 31 of a semiconductor wafer 30 is shown in FIG. 1. The rinsing apparatus 10 includes a pair of rinse units 12 provided on respective sides of a chuck 28 that supports the wafer 30 in a developer coating tool such as a TEL ACT-12 Track tool available from the Tokyo Electron Limited Corp. Each of the rinse units 12 includes a bracket 14 that is mounted to a surface 26 beneath the chuck 28, typically using bracket mount screws 15. A nozzle plate 16 is provided on the bracket 14, and a nozzle 20 is mounted on the nozzle plate 16. Each of the nozzles 20 ejects a water stream 32 against the backside 31 of the wafer 30 to dislodge and remove excess developer solution 36 from the wafer 30.

Each nozzle 20 may be angularly adjustable on the corresponding nozzle plate 16 typically by manual manipulation of an angular adjusting screw 24 in an angular adjusting slot 22. Additionally, the nozzle plate 16 may be linearly adjustable on the bracket 14 typically by manual manipulation of a linear adjusting screw 18. Accordingly, a dispensing range 34, which represents the range of contact of each water stream 32 against the backside 31 of the wafer 30, may be achieved by linear and angular manual adjustment of the nozzle 20. However, such manual adjustment of the dispensing range 34 of the respective rinse units 12 requires much fine-tuning of the respective nozzles 20 in order to achieve optimal rinsing and cleaning of the wafer 30. This fine-tuning procedure is labor-intensive and time-consuming. Accordingly, a system is needed for automatically adjusting the dispensing position of each nozzle for timely, efficient and optimal removal of developer solution from the backside of a wafer.

An object of the present invention is to provide a new and improved system for rinsing substrates.

Another object of the present invention is to provide a new and improved system which is suitable for rinsing developer solution from semiconductor wafer substrates.

Yet another object of the present invention is to provide a new and improved system which may be adapted to rinsing and cleaning substrates in a variety of industrial and mechanical applications.

Still another object of the present invention is to provide a substrate-rinsing system which is automatically adjustable.

Yet another object of the present invention is to provide a new and improved system which is capable of dispensing a cleaning liquid against a substrate across a large surface area on the substrate.

A still further object of the present invention is to provide a new and improved substrate-rinsing system which includes a nozzle that is both angularly and linearly adjustable for dispensing a cleaning liquid against a substrate.

Yet another object of the present invention is to provide a substrate-rinsing system which is versatile and is capable of facilitating timely and efficient adjustment of nozzle-dispensing positions during rinsing or cleaning of a substrate.

### SUMMARY OF THE INVENTION

In accordance with these and other objects and advantages, the present invention is generally directed to a new and improved system for rinsing substrates. The substrate-rinsing system includes at least one rinsing unit having a nozzle that is angularly and linearly adjustable with respect to the substrate. A controller may be used to automatically control the angular and linear positions of the nozzle during the substrate-rinsing procedure in order to facilitate timely and effective rinsing or cleaning of the substrate.

### BRIEF DESCRIPTION OF THE DRAWINGS

The invention will now be described, by way of example, with reference to the accompanying drawings, in which:

FIG. 1 is a side view of a typical conventional substrate rinsing system;

FIG. 2 is a side view of an illustrative embodiment of the automatically-adjusting substrate rinsing system of the present invention;

FIG. 2A illustrates a preferred range of linear and angular positions of a rinsing liquid spray against the backside of a substrate in typical application of the present invention;

FIG. 3 is a top view of a rinsing unit of the automatically-adjusting substrate rinsing system of the present invention, illustrating angular and linear adjustment of a nozzle on the rinsing unit;

FIG. 4 is a side view of a rinsing unit of the automatically-adjusting substrate rinsing system, illustrating linear adjustment of a nozzle on the rinsing unit;

FIG. 5 is an operational schematic illustrating automatic linear positioning of the nozzle on each rinsing unit of the automatically-adjusting substrate rinsing system; and

FIG. 6 is an operational schematic illustrating automatic angular positioning of the nozzle on each rinsing unit of the automatically-adjusting substrate rinsing system.

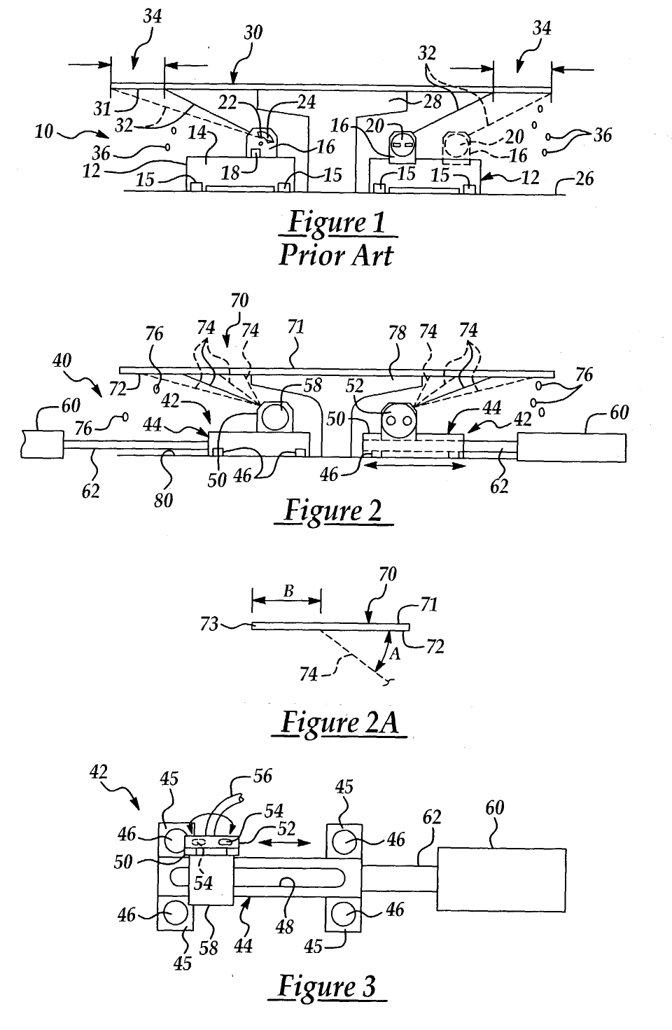

### DESCRIPTION OF THE PREFERRED EMBODIMENTS

The present invention has particularly beneficial utility in the rinsing of excess developer solution from the backside of semiconductor wafers during the fabrication of semiconductor integrated circuits on the wafers. However, the invention is not so limited in application, and while references may be made to such developer solution and semiconductor wafers, the present invention is more generally applicable to rinsing substrates in a variety of industrial and mechanical applications.

Referring next to FIGS. 2-4, an illustrative embodiment of the substrate rinsing system 40 of the present invention is suitably adapted for installation in a developer coating tool such as a TEL ACT-12 Track tool available from the Tokyo Electron Limited Corp., although the invention is applicable to other types of substrate-coating apparatus. As hereinafter described, the substrate rinsing system 40 is effective in rinsing the backside 72 of a semiconductor wafer 70 in order to remove excess liquid developing solution 76 from the backside 72 of the wafer 70. Prior to the rinsing step which is carried out using the substrate rinsing system 40, in the manner hereinafter described, the developing solution 76 is applied to the wafer 70 as the wafer 70 is rotated by a wafer chuck 78 inside a developer-coating. After the excess developing solution 76 is rinsed from the wafer backside 72, the developing solution 76 remaining on the front side or patterned surface 71 of the wafer 70 is used in a subsequent processing step to develop photoresist (not shown) coated on the wafer 70. Next, circuit patterns are etched in a conductive layer (not shown) coated by the photoresist, as is well-known by those skilled in the art.

The substrate rinsing system 40 of the present invention includes at least one, and preferably, pair of rinsing units 42 which are provided in the developer dispensing tool (not shown), on opposite sides of the wafer chuck 78. Each of the rinsing units 42 includes a bracket or other suitable support 44 that is mounted to a mount surface 80 beneath the chuck 78, typically using bracket mount screws 46 that are extended through each of multiple bracket mount flanges 45, as shown in FIG. 3, and threaded into the mount surface 80. It is understood that a variety of alternative techniques known by those skilled in the art may be used to mount each rinsing unit 42 on the mount surface 80. An upward-standing nozzle plate 50 slidably engages an elongated linear adjusting slot 48 (FIG. 3) provided in the bracket 44 of each rinsing unit 42, according to the knowledge of those skilled in the art. An electric angular adjusting stepper motor 58 is mounted on the nozzle plate 50. A motor shaft (not shown), engaged by the angular adjusting stepper motor 58, extends through a shaft opening (not shown) provided in the nozzle plate 50 and engages a nozzle 52, having a nozzle opening 54 (FIG. 3), on the opposite side of the nozzle plate 50. A liquid supply tube 56 establishes fluid connection between the nozzle 52 and a reservoir or tank (not shown) containing a supply of a rinsing liquid 74 (FIG. 2) such as water.

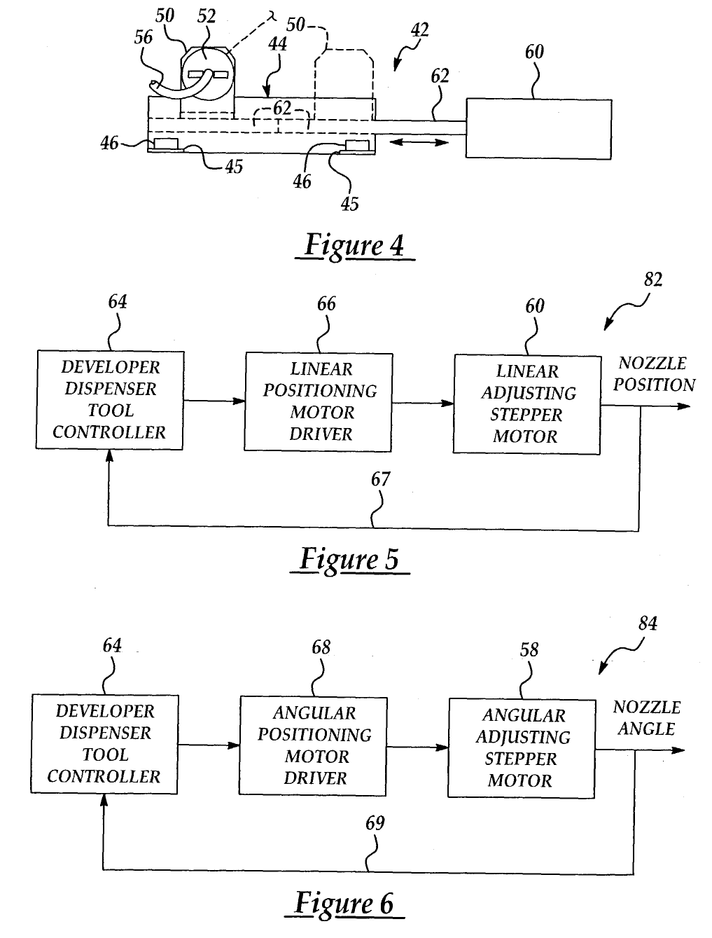

As shown in FIG. 4, one end of an elongated adjusting arm 62 is engaged by an electric linear adjusting stepper motor 60. The opposite or extending end of the adjusting arm 62 engages the bottom portion of the nozzle plate 50. Accordingly, by slidably extending or retracting the adjusting arm 62 in the bracket 44 by operation of the linear adjusting stepper motor 60, the linear position of the nozzle plate 50 along the bracket 44 may be adjusted between the distal position of the nozzle plate 50, as indicated by the solid lines, and the proximal position of the nozzle plate 50, as indicated by the phantom lines.

Referring next to FIG. 5, a control schematic 82 for the linear adjusting stepper motor 60 of each rinsing unit 42 is shown. The developer dispensing tool controller 64 is operably connected to a linear positioning motor driver 66, which in turn is operably connected to the linear adjusting stepper motor 60. Accordingly, responsive to input from the tool controller 64, which is supported by enabling software, the linear positioning motor driver 66 signals the linear adjusting stepper motor 60 to extend or retract the adjusting arm 62 (FIGS. 3 and 4) and thereby locate the nozzle plate 50 at a selected position along the length of the bracket 44. A position sensor (not shown) may be provided on the bracket 44 to sense the linear position of the nozzle plate 50 along the bracket 44, according to the knowledge of those skilled in the art. This information is transmitted back to the tool controller 64 through a feedback loop 67.

Referring next to FIG. 6, a control schematic 84 for the angular adjusting stepper motor 58 of each rinsing unit 42 is shown. The developer dispensing tool controller 64 is operably connected to an angular positioning motor driver 68, which in turn is operably connected to the angular adjusting stepper motor 58 on each rinsing unit 42. Accordingly, responsive to input from the tool controller 64, which is supported by enabling software, the angular positioning motor driver 68 signals the angular adjusting stepper motor 58 to rotate the nozzle 52 and thereby locate the nozzle opening 54 at a selected position, as shown in FIG. 3. A position sensor (not shown) may be provided on the nozzle plate 50 to sense the rotational position of the nozzle 52 with respect to the nozzle plate 50, according to the knowledge of those skilled in the art. This information is transmitted back to the tool controller 64 through a feedback loop 69.

In operation of the substrate rinsing system 40, the chuck 78 rotates the wafer 70 above the rinsing units 42. Simultaneously, the nozzles 52 on the respective rinsing units 42 eject a stream of the rinsing liquid 74 against the backside 72 of the wafer 70 to dislodge and remove excess developer solution 76 from the wafer backside 72. Accordingly, the rinsing liquid 74 is distributed from the rinsing liquid reservoir tank (not shown), through the liquid supply tube 56, and out the nozzle 52 through the nozzle opening 54 (FIG. 3) therein. As shown in FIG. 2, the rinsing liquid 74 may be directed against a substantially widespread area on the wafer backside 72 responsive to both linear and angular adjustment of the nozzle opening 54 with respect to the wafer backside 72. The linear position of the nozzle opening 54 of each rinsing unit 42 with respect to the wafer backside 72 is controlled by the linear adjusting stepper motor 60, typically via input from the tool controller 64 and the linear positioning motor driver 66, as shown by the schematic 82 in FIG. 5. The angular position of the nozzle opening 54 of each rinsing unit 42 with respect to the wafer backside 72 is controlled by the angular adjusting stepper motor 58, typically via input from the tool controller 64 and the angular positioning motor driver 68, as shown by the schematic 84 in FIG. 6. Accordingly, the tool controller 64 may be programmed to facilitate a scanning motion of the streams of rinsing liquid 74 against the wafer backside 72 for a selected period of time, according to the knowledge of those skilled in the art, through combined actuation of the linear adjusting stepper motor 60 and the angular adjusting stepper motor 58. As shown in FIG. 2A, during scanning of the rinsing liquid stream 74 along and against the wafer backside 72, the angular position of the nozzle opening 54 (FIG. 3) with respect to the wafer backside 72 is preferably selected in such a manner that the angle “A” of the rinsing liquid stream 74 with respect to the plane of the wafer backside 72 ranges from about 20 degrees to about 30 degrees. Preferably, the rinsing liquid stream 74 strikes the wafer backside 72 throughout a distance range “B” of from about 20 mm to about 35 mm from the edge 73 of the wafer 70. Alternatively, the tool controller 64 may be programmed to facilitate ejection of the streams of rinsing liquid 74 against the wafer backside 72 at a selected linear position and a selected angular position of the nozzle opening 54 with respect to the wafer backside 72 for a selected period of time, after which the nozzle openings 53 of the respective nozzles 52 are shifted to new linear and angular positions for a selected period of time until substantially all of the developing solution 76 has been rinsed from the wafer backside 72. It will be appreciated by those skilled in the art that the positional versatility of the nozzles 52, imparted by the linear and angular adjustment features of the respective rinsing units 42, enables exposure of substantially the entire backside 72 of the wafer 70 which may be covered by the excess developing solution 72, to the streams of rinsing liquid 74. Those of skill in the art will recognize that numerous software recipes are possible to automatically control the various possible linear and angular positions of the nozzles 52 with respect to the wafer backside 72 for thorough removal of the developing solution 76 therefrom.

While the preferred embodiments of the invention have been described above, it will be recognized and understood that various modifications can be made in the invention and the appended claims are intended to cover all such modifications which may fall within the spirit and scope of the invention.

What is claimed is:

1. A substrate rinsing system for rinsing a substrate, comprising at least one rinsing unit comprising:
a support;
a nozzle carried by said support for ejecting a rinsing liquid against the substrate;
a linear adjusting mechanism operably engaging said nozzle for facilitating automatic linear adjustment of said nozzle with respect to the substrate; and
an angular adjusting mechanism operably engaging said nozzle for facilitating automatic angular adjustment of said nozzle with respect to the substrate.

2. The substrate rinsing system of claim 1 wherein said at least one rinsing unit comprises a pair of rinsing units provided in spaced-apart relationship to each other.

3. The substrate rinsing system of claim 1 wherein said linear adjusting mechanism comprises an adjusting arm operably engaging said nozzle for linear adjustment of said nozzle along said support and a linear adjusting stepper motor engaging said adjusting arm for actuating said adjusting arm.

4. The substrate rinsing system of claim 1 wherein said angular adjusting mechanism comprises an angular adjusting stepper motor operably engaging said nozzle for angular adjustment of said nozzle with respect to said support.

5. The substrate rinsing system of claim 1 further comprising a controller operably connected to said linear adjusting mechanism and said angular adjusting mechanism for facilitating said automatic linear adjustment and said automatic angular adjustment, respectively.

6. The substrate rinsing system of claim 5 wherein said at least one rinsing unit comprises a pair of rinsing units provided in spaced-apart relationship to each other.

7. The substrate rinsing system of claim 5 wherein said linear adjusting mechanism comprises an adjusting arm operably engaging said nozzle for linear adjustment of said nozzle along said support and a linear adjusting stepper motor engaging said adjusting arm for actuating said adjusting arm.

8. The substrate rinsing system of claim 5 wherein said angular adjusting mechanism comprises an angular adjusting stepper motor operably engaging said nozzle for angular adjustment of said nozzle with respect to said support.

9. A substrate rinsing system for rinsing a substrate, comprising at least one rinsing unit comprising:
an elongated support;
a nozzle plate slidably engaging said support;
a nozzle carried by said nozzle plate for spraying a rinsing liquid against the substrate;
a linear adjusting mechanism operably engaging said nozzle plate for facilitating automatic linear adjustment of said nozzle with respect to the substrate; and
an angular adjusting mechanism operably engaging said nozzle for facilitating automatic angular adjustment of said nozzle with respect to the substrate.

10. The substrate rinsing system of claim 9 wherein said at least one rinsing unit comprises a pair of rinsing units provided in spaced-apart relationship to each other.

11. The substrate rinsing system of claim 9 wherein said linear adjusting mechanism comprises an adjusting arm operably engaging said nozzle plate for linear adjustment of said nozzle plate along said support and a linear adjusting stepper motor engaging said adjusting arm for actuating said adjusting arm.

12. The substrate rinsing system of claim 9 wherein said angular adjusting mechanism comprises an angular adjusting stepper motor operably engaging said nozzle for angular adjustment of said nozzle with respect to said support.

13. The substrate rinsing system of claim 9 further comprising a controller operably connected to said linear adjusting mechanism and said angular adjusting mechanism for facilitating said automatic linear adjustment and said automatic angular adjustment, respectively.

14. The substrate rinsing system of claim 13 wherein said at least one rinsing unit comprises a pair of rinsing units provided in spaced-apart relationship to each other.

15. The substrate rinsing system of claim 13 wherein said linear adjusting mechanism comprises an adjusting arm operably engaging said nozzle plate for linear adjustment of said nozzle plate along said support and a linear adjusting stepper motor engaging said adjusting arm for actuating said adjusting arm.

16. The substrate rinsing system of claim 13 wherein said angular adjusting mechanism comprises an angular adjusting stepper motor operably engaging said nozzle for angular adjustment of said nozzle with respect to said support.

17. A substrate rinsing system for rinsing a substrate, comprising a pair of spaced-apart rinsing units each comprising:
an elongated support;
a nozzle plate slidably engaging said support;
a nozzle rotatably carried by said nozzle plate for spraying a rinsing liquid against the substrate;
a linear adjusting mechanism operably engaging said nozzle plate for facilitating automatic linear adjustment of said nozzle with respect to the substrate; and
an angular adjusting mechanism operably engaging said nozzle for rotating said nozzle on said nozzle plate and facilitating automatic angular adjustment of said nozzle with respect to the substrate.

18. The substrate rinsing system of claim 17 further comprising a controller operably connected to said linear adjusting mechanism and said angular adjusting mechanism for facilitating said automatic linear adjustment and said automatic angular adjustment, respectively.

19. The substrate rinsing system of claim 18 wherein said linear adjusting mechanism comprises an adjusting arm operably engaging said nozzle plate for linear adjustment of said nozzle plate along said support and a linear adjusting stepper motor engaging said adjusting arm for actuating said adjusting arm.

20. The substrate rinsing system of claim 18 wherein said angular adjusting mechanism comprises an angular adjusting stepper motor operably engaging said nozzle for angular adjustment of said nozzle with respect to said support.
